(19) United States
(12) Patent Application Publication
(10) Pub. No.: US 2009/0152113 A1
(43) Pub. Date: Jun. 18, 2009

(54) Gas detection system

(76) Inventors: Kuo-Chuang Chiu, Hsinchu City (TW); Ren-Der Jean, Hsinchu City (TW)

Correspondence Address: HARNESS, DICKEY & PIERCE, P.L.C., P.O. BOX 8910, RESTON, VA, 20195, US

(21) Appl. No.: 12/379,089

(22) Filed: Feb. 12, 2009

Related U.S. Application Data
(63) Continuation-in-part of application No. 10/928,208, filed on Aug. 30, 2004.

(30) Foreign Application Priority Data
May 4, 2004 (TW) 93112496

(51) Int. Cl. G01N 27/26

(52) U.S. Cl. 204/406

(57) ABSTRACT

A gas detection system used for detecting a concentration of a gas in a second environment based on a concentration of the gas in a first environment is provided. The gas detection system may include a gas detecting device having two detection module, a first dielectric layer a second dielectric layer and a programmed control module. The control module may detect the voltage outputted by the first detection module to obtain the concentration of the gas in the second environment, when the detected voltage is smaller than a predetermined value. The control module may output a voltage signal to the second detection module and may detect the steady state current corresponding to the voltage signal to obtain the concentration of the gas in the second environment corresponding to the steady state current.

### CROSS-REFERENCE TO RELATED APPLICATIONS

This application is a continuation-in-part (CIP) of U.S. patent application Ser. No. 10/928,208, filed on Aug. 30, 2004, which claims priority under 35 U.S.C. §119 to Taiwanese Patent Application No. 93112496, filed May 4, 2004, the entire contents of which are hereby incorporated.

### BACKGROUND

1. Field of Invention

The invention relates to a gas detection system and, in particular, to a gas concentration detection system.

2. Related Art

Sensors are indispensable devices in automatic detecting systems and automatic control systems. Whether a sensor can correctly measure the detected quantity and convert it into the corresponding output quantity plays an important role in the precision of a system. According to different types of detected quantities, there are physical sensors that measure physical characteristic such as light, magnetism, temperature and pressure, and chemical sensors that measure chemical characteristic such as humidity and gas.

Normally, a gas sensor uses a special material whose electrical properties change after being adsorbed with certain gas. Since ceramic materials have superior detecting functions (e.g. high tolerance in heat, corrosion, and etching), they are widely used in the reaction layer of gas sensors. Some ceramic detecting materials are particularly sensitive to oxidization and reduction. They are ideal for detecting the component or temperature change of special gas. For example, ZrO₂—Y₂O₃ is an oxygen ion conductive ceramic whose feature is that its oxygen ions have high mobility at high temperatures. Thus, its conductivity changes with the oxygen concentration as a result of defects in the crystal. When ZrO₂—Y₂O₃ is used in an oxygen sensor, platinum electrodes are coated on both sides of the ceramic after sintering as the oxidization catalyst. When oxygen ions move, an electric motif is generated with the magnitude determined by the oxygen on the platinum electrodes.

As described in the conventional art, the structure and manufacturing method of a conventional flat ceramic sensor usually employ multilayer ceramic processes to form a flat gas sensor. A ZrO₂ ceramic substrate is used as the main structure material, followed by forming electrodes, dielectric ceramics, a reference gas cavity, and a solid-state electrolyte therein. As the solid-state electrolyte is a plate, it requires a lot of detecting materials. At the same time, the rigidity of the plate is worse. Therefore, the conventional art proposes another manufacturing method for flat ceramic sensors. It also uses a dielectric as its main structure with a cavity formed therein to accommodate a reference gas. Its structure includes a stack of porous ceramic layer, an electrode layer, a solid-state electrolyte layer, and a carbon substrate with a cavity. The gas inside the cavity is the reference gas. It also includes a heating electrode as the heating device of the sensor. However, the solid-state electrolyte layer has a hole on one end of a dielectric ceramic plate that is filled with a solid-state dielectric material as its reaction region. The upper and lower surfaces of the reaction region are formed with electrodes to reduce the use of solid-state dielectric materials.

### SUMMARY

Example embodiments provide a gas detection system for detecting a wide range of gas concentration.

The gas detection system may be adopted for detecting a concentration of a gas contained in a second environment based on a concentration of the gas contained in a first environment. The gas detection system may include a gas detection device and a programmed control module. The gas detection device may include a first detection module, a second detection module, a first dielectric layer and a second dielectric layer. Each of the first detection module and the second detection module may include a first electrode, a second electrode, a reaction layer and multiple detection pillars. The first electrode may have a surface and may be exposed to the second environment. The reaction layer may be disposed between the first electrode and the second electrode. The detection pillars may be inserted in the reaction layer, wherein two ends of the each pillar may be connected to the first electrode and the second electrode, respectively. The first dielectric layer may be disposed between the two second electrodes. The first dielectric layer may have a through hole and a heating electrode. The second electrode may be disposed at the two end of the through hole. The through hole may communicate with the first environment. The second dielectric layer may be disposed on the first electrode of the second detection module. The second dielectric layer may have a cavity with an opening and a diffusion hole communicating the cavity with the second environment. The first electrode of the second detection module may be located at the opening. The programmed control module respectively may be connected to the first electrodes and the second electrodes. The control module may detect the voltage output from the first detection module to obtain the concentration of the gas contained in the second environment, when the detected voltage is smaller than a value. The control module may output a voltage signal to the second detection module and may detect a steady state current corresponding to the voltage signal to obtain the concentration of the gas contained in the second environment corresponding to the steady state current.

Based on the structure disclosed above, the gas detection system may detect the concentration of the gas contained in the second environment under the circumstance that the voltage output from the first detection module may be higher than a value. In addition, the detection system may detect the concentration of the gas contained in the second environment by apply the voltage signal to the second detection module and may detect the corresponding steady state current in the circumstance that the voltage output from the first detection module is lower than the value. Accordingly, example embodiments may achieve at least one effect of detecting a wide range of gas concentration detection.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of an example embodiment of the invention;

FIG. 2 is a schematic view of an other example embodiment of the invention;

FIG. 3 is a schematic view of another example embodiment of the invention; and

FIG. 4 is a schematic view of the gas detection device in FIG. 3.

### DETAILED DESCRIPTION OF EXAMPLE EMBODIMENTS

Example embodiments disclose an oxygen sensor. The ceramic oxygen sensor contains an upper electrode, a reaction layer, a lower electrode, and a ceramic cavity layer. In this embodiment, the upper and lower electrodes are platinum electrodes. The ceramic substrate of the reaction layer and the ceramic cavity layer are ZrO₂ substrates with ZrO₂—Y₂O₃ being the detecting material.

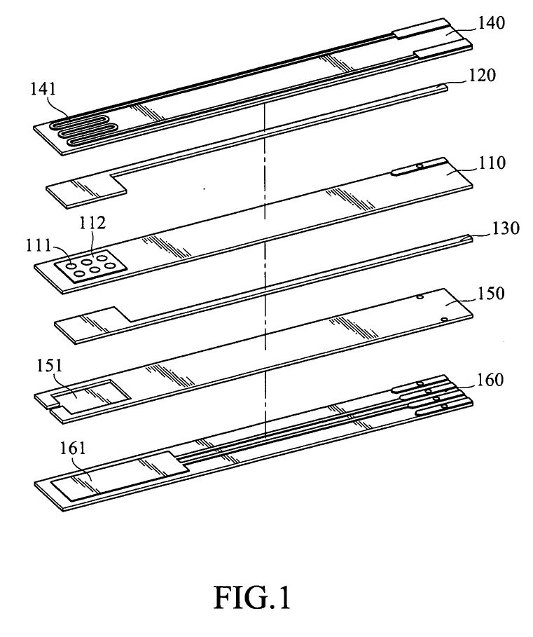

As shown in FIG. 1, the reaction layer 110 is a ceramic substrate with a reaction region on one end. The ceramic substrate has an upper surface and a lower surface. The reaction region contains several duct holes 111 penetrating through the upper and lower surfaces of the ceramic substrate and a reaction film 112 covering the upper surface of the ceramic substrate. The reaction film is made of a detecting material and connected to the duct holes 111. The duct holes are also filled with the detecting material for the reaction film 112. The upper electrode 120 is attached on the reaction film 112. The lower electrode 130 is attached on the lower surface of the reaction layer 110 and connected to the duct holes 111. The ceramic cavity layer 150 is provided on the lower surface of the reaction layer 110 with the lower electrode 130 in between. The ceramic cavity layer 150 has a cavity 151 connecting with the environment and adjacent to the lower electrode 130.

Normally, the oxygen sensor can function normally only under high temperatures. Therefore, one can include a heating device and a temperature detecting device in the oxygen sensor. As shown in FIG. 1, the heating device 140 is a ceramic substrate with a heating electrode 141 coated on its surface. The heating electrode 141 is in touch with the upper electrode 120. The temperature detecting device 160 is a ceramic substrate with a temperature detecting electrode 161 coated on its surface. The temperature detecting electrode 161 is in touch with the ceramic cavity layer 50.

Since example embodiments may be formed using a multilayer ceramic structure, it can be accomplished by the layer-stacking ceramic manufacturing technology. For example, ceramic substrates of different thickness can be made by scraping. The duct holes in the reaction layer and the cavity in the ceramic cavity layer can be formed by wafer hole machining. The detecting material is filled into the duct holes and coated on the electrode using high precision half-tone printing. Finally, all the ceramic layers are stacked together for sintering.

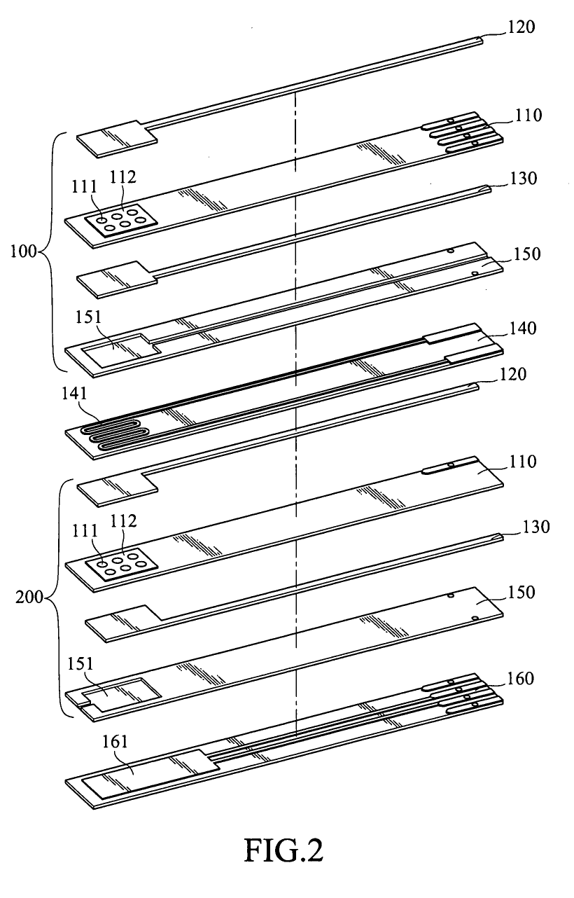

The detecting ability of the invention can be improved by combining several gas sensors. As shown in FIG. 2, a combinatory concentration oxygen detecting device 100 and a threshold current oxygen detecting device 200 form a multilayer ceramic oxygen sensor. The combinatory concentration oxygen detecting device 100 provides a voltage in order to feed back the electric power needed by the system. The threshold current oxygen detecting device 200 obtains an induced current from an imposed voltage.

As shown in FIG. 2, the combinatory concentration oxygen detecting device 100 has an upper electrode 120, a reaction layer 110, a lower electrode 130, and a ceramic cavity layer 150. The reaction layer 110 is a ceramic substrate with a reaction region provided on one end. The ceramic substrate has an upper surface and a lower surface. The reaction region contains several duct holes 111 penetrating through the upper and lower surfaces of the ceramic substrate and a reaction film 112 covering the upper surface of the ceramic substrate. The reaction film 112 is made of a detecting material and connected to the duct holes 111. The duct holes are also filled with the detecting material for the reaction film 112. The upper electrode 120 is attached on the reaction film 112. The lower electrode 130 is attached on the lower surface of the reaction layer 110 and connected to the duct holes 111. The ceramic cavity layer 150 is provided on the lower surface of the reaction layer 110 with the lower electrode 130 in between. The ceramic cavity layer 150 has a cavity 151 connecting with the environment and adjacent to the lower electrode 130. The combinatory concentration oxygen detecting device 100 and the threshold current oxygen detecting device 200 are divided by a heating device 140. The heating device 140 is a ceramic substrate whose surface is coated with a heating electrode 141. The heating device 140 is installed below the ceramic cavity layer 150 of the combinatory concentration oxygen detecting device 100 and above the upper electrode 120 of the threshold current oxygen detecting device 200. The threshold current oxygen detecting device 200 has a similar structure with stacked upper electrode 120, reaction layer 110, lower electrode 130, and ceramic cavity layer 150. The upper electrode 120 and the lower electrode 130 sandwich the reaction layer 110. The reaction layer 110 is a ceramic substrate with a reaction region provided on one end. Its reaction region contains several duct holes 111 penetrating through the upper and lower surfaces of the ceramic substrate and a reaction film 112 covering the upper surface of the ceramic substrate. The ceramic cavity layer 150 is then installed with the lower electrode 130 inserted in between. The ceramic cavity layer 150 has a cavity 151 connecting to the environment. A temperature detecting device 160 is provided at the bottom of the threshold current oxygen detecting device 200. The temperature detecting device 160 is a ceramic substrate whose surface is coated with a temperature detecting electrode 161. The temperature detecting electrode 161 is in touch with the ceramic cavity layer 50 of the threshold current oxygen detecting device 200.

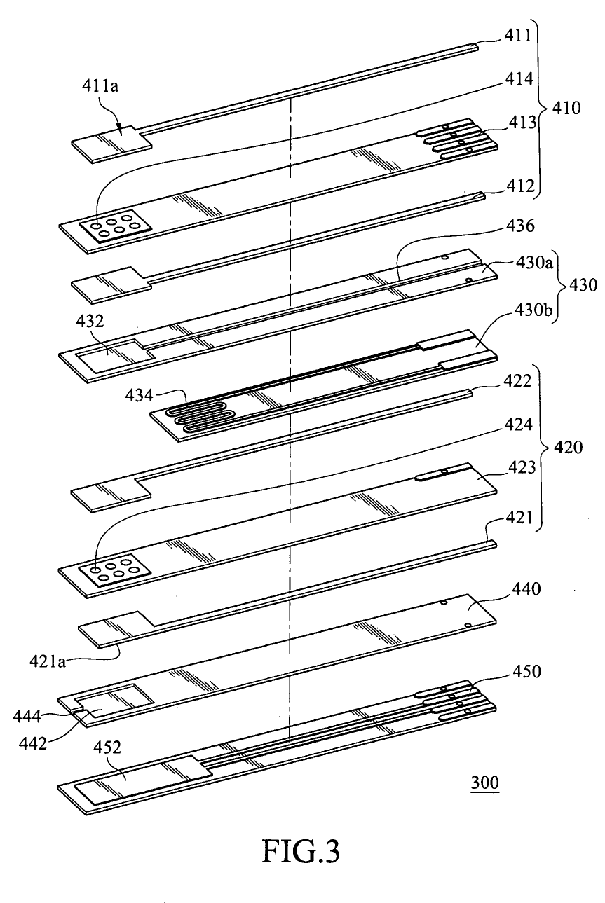

FIG. 3 illustrates a third embodiment of a gas detection system according to this invention. Referring to FIG. 3, the gas detection system 300 is adopted for detecting the concentration of a specific gas, e.g. the oxygen concentration, in a second environment, based on the specific gas, e.g. the oxygen concentration, in a first environment. The gas detection system includes a gas detection device 400 and a programmed control module 500, wherein the control module 500 electrically connected to the gas detection device 400 by which the control module 500 obtains the concentration of the specific gas contained in the second environment.

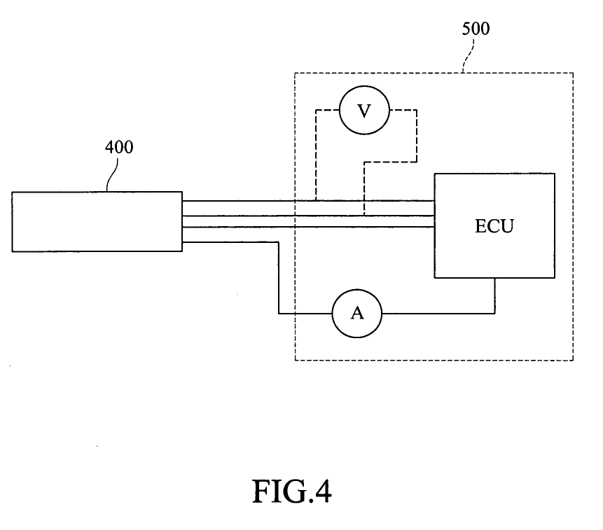

FIG. 4 illustrates the gas detection device in FIG. 3. Referring to FIG. 4, the gas detection device 400 includes a first detection module 410, a first dielectric layer 420, a second detection module 430 and a second dielectric layer 440. The first detection module 410 includes a first electrode 411, a second electrode 412, a reaction layer 413 and multiple detection pillars 414. A surface 411a of the first electrode 411 is exposed in the second environment. The reaction layer 413 is sandwiched in between the first electrode 411 and the second electrode 412. Each of the detection pillars 414 is inserted in the reaction layer 413. Two opposite ends of each pillar 414 are connected to the first electrode 411 and the second electrode 412, respectively.

The second detection module 420 includes a first electrode 421, a second electrode 422, a reaction layer 423 and multiple detection pillars 424. The reaction layer 432 is sandwiched in between the first electrode 421 and the second electrode 422. Each of the detection pillars 414 is inserted in the reaction layer 423. Two opposite ends of each pillar 424 are connected to the first electrode 421 and the second electrode 422, respectively.

The first dielectric layer 430 is sandwiched in between the first electrode 412 and the second electrode 422. The first dielectric layer 430 with a through hole 432 has a heating electrode 434. The second electrode 412 of the first detection module 410 and the second electrode 422 of the second detection module 420 are disposed on two opposite ends of the through hole 432 communicating with the first environment.

In this example embodiment, the first dielectric layer 430, for example, is composed of a sub-dielectric layer 430a and a sub-dielectric layer 430b stacking on the sub-dielectric layer 430a. The sub-dielectric layer has the through hole 432 and a channel 436, wherein the through hole 432 communicates with the first environment via the channel 436. Thereby, the mixed gas, e.g. the air, may flow in the through hole via the channel 436. The sub-dielectric layer 430b has a heating electrode 434. Particularly, the through hole 432 does not overlap the heating electrode 434, while the sub-dielectric layer 430a stacks on the sub-dielectric layer 430b.

The second dielectric layer 440 is disposed on the first electrode 42. More particularly, the second dielectric layer 440 is sandwiched in between the first electrode 412 and the reaction 423.

The second dielectric layer 440 has a cavity 442 with an opening and a diffusion hole 444 communicating the first environment with the cavity 442. The first electrode 421 is located on the opening of the cavity 442. Therefore, the mixed gas of the second environment, e.g. the exhaust gas of an automobile, diffuse in the cavity 422 via the diffusion hole 444 and contact with the first electrode.

Referring to FIG. 3 and FIG. 4, the control module 500 electrically connected to the first electrode 411, the second electrode 412, the first electrode 421 and the second electrode 422.

Description of the operation of the gas detection system 300 and the controlling mechanism of the control module are given as follows. To facilitate the understanding of the invention, a detection of the concentration of the oxygen contained in the exhaust gas discharged by an automobile is taken as an example, wherein the first environment is the circumstance outside the automobile and the second environment is the circumstance inside the tailpipe of the automobile. Furthermore, the first electrode 411, the second electrode 412, the first electrode 421 and the second electrode 422 are, for example, made of platinum. The detection pillars are, for example, made of ZrO₂—Y₂O₃.

When the exhaust gas in the tailpipe contacts with the first electrode 411 of the first detection module 410, and air of the circumstance outside the automobile contacts with the second electrode 412 of the first detection module 410 via the channel 436 and the through hole 432, the second electrode 412 serves as a catalyst to transform the oxygen of the air into oxygen ions and electrons under the heating of the heating electrode 434. Then, the oxygen ions transmit from the second electrode 412 to the first electrode 411 via the detection pillar 414, and obtain electrons at the first electrode 411. As a result, the concentration of the oxygen contained in the exhaust gas is obtained by detecting the voltage difference between the first electrode 412 and the second electrode 412 through the control module. However, to detect the oxygen concentration in the exhaust gas by the first detection module 410 and the control module 500, the partial pressure oxygen of the air must be higher than that of the exhaust gas by a specific amount to make the oxygen ions migrate from the second electrode 412 to the first electrode 411. According, there exists a minimum voltage that the control module 500 may detect from the first detection module.

In addition, to more precisely control the temperature of the heating electrode 434, the gas detection system may further comprise a temperature detection layer 450. The second dielectric layer 440 is sandwiched in between the first electrode 452 of the second detection module 420 and the temperature detection layer 450. The temperature detection layer 450 has a temperature detection electrode 452 electrically connected to the control module 500. Therefore, the control module 500 is capable of monitoring and controlling the temperature of the heating electrode 434 via the temperature detection electrode 452.

In addition, the programmed control module 500 is programmed and has a predetermined value which is equal to or larger than the critical voltage. When the voltage outputted from the first detection module 400 is smaller than the predetermined value, then the control module 500 outputs a voltage signal to the second detection module 420. Then, the control module 500 detects a steady state current value corresponding to the voltage signal is obtained from the second detection module 420 by the control module. Therefore, in case the difference between the partial pressure oxygen of the air and that of the exhaust oxygen is smaller than the specific amount, the oxygen concentration of the exhaust gas, which is too small to be detected by the first detection module 410, may be obtained by the control module 500 by calculating the steady state current value.

Accordingly, because the gas detection system may rely on the first detection module and the control module to detect the oxygen concentration contained in the exhaust gas when the voltage outputted from the first gas detection module is larger than the predetermined vale, and rely on the second detection module and the control module to detect the oxygen concentration contained in the exhaust gas when the voltage outputted from the first gas detection module is smaller than or equal to the predetermined vale. As such, the gas detection system may provide a wide rage oxygen concentration detection.

According to the same principles, the disclosed structure can be used to detect nitrogen, oxygen, or hydrogen. The upper electrodes, the lower electrodes, the first electrodes, the second electrodes in the gas sensor can be selected from the group consisting of platinum, gold, silver, and their alloys. The heating electrode can be made of platinum, tungsten, molybdenum, and their metal oxides. According to different detecting requirements, the detecting material and the material of the detection pillars can be selected from ZrO₂—CaO, ZrO₂—Y₂O₃, ZrO₂—Yb₂O₃, ZrO₂—Sc₂O₃, and ZrO₂—Sm₂O₃. The ceramic substrate of the reaction layer can be selected from the ZrO₂ substrate, aluminum oxide substrate, ZrO₂/aluminum oxide substrate, and ZrO₂/magnesium oxide substrate.

Certain variations would be apparent to those skilled in the art, which variations are considered within the spirit and scope of the claimed invention.

What is claimed is:

1. A gas detection system used for detecting a concentration of a gas contained in a second environment based on a concentration of the gas contained in a first environment, the gas detection system comprising:
a gas detection device, including:
a first detection module;
a second detection module, each of the first detection module and the second detection module includes:
a first electrode with a surface exposed to the second environment;
a second electrode;
a reaction layer, disposed between the first electrode and the second electrode; and
a plurality of detection pillars inserted in the reaction layer, two ends of each of the pillars connected to the first electrode and the second electrode, respectively;
a first dielectric layer disposed between the second electrodes, the first dielectric layer having a through hole and a heating electrode, the second electrode disposed at the two end of the through hole and the through hole communicated with the first environment; and
a second dielectric layer disposed on the first electrode of the second detection module, the second dielectric layer having a cavity with an opening and a diffusion hole communicating the cavity with the second environment, the first electrode of the second detection module being at the opening; and
a programmed control module respectively connected to the first electrodes and the second electrodes, the control module detecting the voltage output from the first detection module to obtain the concentration of the gas contained in the second environment, when the detected voltage is smaller than a value, the control module outputting a voltage signal to the second detection module and detecting a steady state current corresponding to the voltage signal to obtain the concentration of the gas contained in the second environment corresponding to the steady state current.

2. The gas detection system of claim 1, further comprising a temperature detection layer with a temperature detection electrode, the second dielectric layer located between the first electrode of the second detection module and the temperature detection layer.

3. The gas detection system of claim 1, wherein the through hole does not overlap the heating electrode.
